(19) United States
(12) Patent Application Publication
(10) Pub. No.: US 2007/0147851 A1
(43) Pub. Date: Jun. 28, 2007

(54) Marking ID for document identification

(75) Inventor: John Poxon, Stevenage (GB)

Correspondence Address: KEVIN M. DUNN;FAY, SHARPE, FAGAN, MINNICH & McKEE, LLP, SEVENTH FLOOR, 1100 SUPERIOR AVENUE, CLEVELAND, OH, 44114-2579, US

(73) Assignee: XEROX CORPORATION

(21) Appl. No.: 11/317,696

(22) Filed: Dec. 23, 2005

(51) Int. Cl. G03G 15/00

(52) U.S. Cl. 399/2

(57) ABSTRACT

In accordance with one aspect of the present exemplary embodiment, a system marks a document that comprises a processing component that at least one of copies, prints, faxes, configures imaging, staples, collates and hole punches a document. A marking component produces one or more marks on a document received from the processing component. A configuration component allows configuration of the marking component.

### BACKGROUND

The following relates to document identification. It finds particular application in utilizing one or more techniques to create a distinguishing mark on a document for identification purposes.

Traditionally, original master documents and forms have a colored stamp “ORIGINAL” to identify such documents as an original document. Alternatively, a colored square can be located somewhere on the document to provide such an original identification. Typically, when copies of the original document containing the colored square and/or colored text are made, all color in the document is converted to black and white. In one example, blue text and/or a red square on an original master document is converted to black when one or more original copies are created. In this manner, the original is easily distinguished from copies of the original document. Such a system relies on the scarcity and/or minimal usage of color in standard (e.g., non-original master) documents.

Recently, advancements in technology have made printing and/or copying color documents almost equal in cost to black and white documents. As a result, the use of color with document processing has become more prevalent and is a less distinguishing characteristic of a document. Users cannot determine if a document is an original master or merely a copy of such an original. Thus, an original document can easily be confused with a copy.

One problem associated with this development is that documents could be modified to contain and/or not contain information that was not included on the original document. Such information modification could happen once or over a period of several iterations such that one document could simultaneously have several concurrent versions utilized by one or more personnel. Consequently, control of document content and quality is compromised.

In order to remedy this problem, alternative systems and methods need to be employed to more accurately identify original documents. Such identification can provide more consistent and accurate control over the content contained in original documents and copies of such original documents.

### BRIEF DESCRIPTION

In one aspect, a system marks a document that comprises a processing component that at least one of copies, prints, faxes, configures imaging, staples, collates and hole punches a document. A marking component produces one or more marks on a document received from the processing component. A configuration component allows configuration of the marking component.

In another aspect, a multifunction printing platform copies information from an original document to one or more document copies. A charge component deposits a uniform electrostatic on a photoreceptor surface a discharge. An expose component that exposes the photoreceptor of the charge component with an optical image of the information to be reproduced from the original document. A develop component transfers electrostatically charged toner particles that are brought into contact with the latent image wherein charged toner particles are transferred to the surface of the photoreceptor of the charge component, wherein the toner particles are representative of the information to be transferred from the original document to at least one document copy. A transfer component transfers the toner particles from the photoreceptor to the at least one document copy. A fix component fuses the toner particles transferred to the at least one document copy by the transfer component. A marking component places one or more marks on a document received from the fix component. A configuration component configures one or more attributes of the one or more marks placed by the marking component.

In yet another aspect, a method is employed to mark a document to distinguish an original document from a copy. Processing of a document is configured which includes at least one of stapling, binding, punching, copying, faxing, printing, and image manipulation on a document. Marking of the document is configured by determining at least one of mark location, mark depth, mark size, marker type, and mark content. The document is received and processed by at least one of stapling, binding, punching, copying, faxing, printing, and image manipulation of the document based at least upon the configuration of the processing of the document. The document is marked with a permanent indentation based at least upon configuration of the marking of the document that provides at least one characteristic that distinguishes an original document from a document copy.

### BRIEF DESCRIPTION OF THE DRAWINGS

FIG. 1 illustrates a system that marks a document received from a processing component;

FIG. 2 illustrates a multifunction printing platform that processes and marks one or more document copies;

FIG. 3 illustrates a system that marks a document received from a processing component via a roller marking component;

FIG. 4 illustrates a multifunction printing platform that marks a document via a dot matrix marker;

FIG. 5 illustrates a method of processing and marking a document;

FIG. 6 illustrates an exemplary user interface to configure marking of one or more documents;

FIG. 7 illustrates an exemplary user interface to configure marking of one or more documents;

FIG. 8 illustrates an exemplary user interface to configure marking of one or more documents.

### DETAILED DESCRIPTION

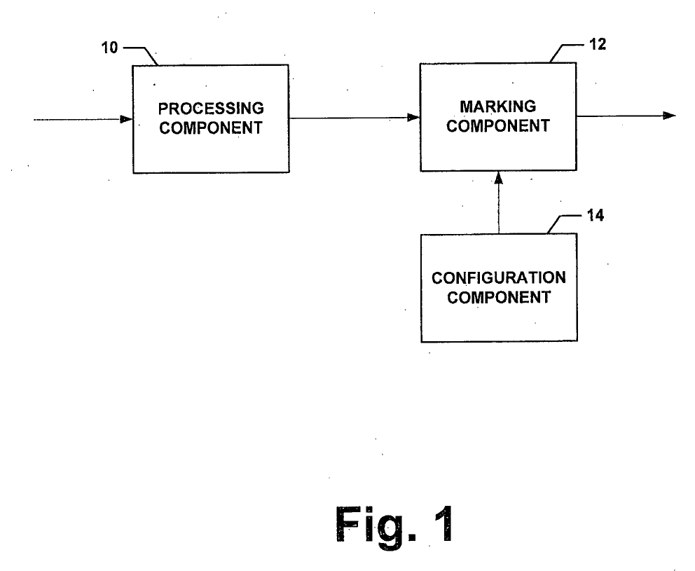

With reference to FIG. 1, a system that marks one or media includes a processing component 10, a marking component 12 and a configuration component 14. The processing component 10 processes one or more media to provide copies of a document, print a document, fax a document, or otherwise configure imaging on a document. Processing can further include stapling, collating, hole punching, etc. Such processing can occur on substantially any media type such as paper, acetate, vellum, etc. In addition, the size of the media can vary such that substantially any size can be processed. For example, media can be letter size, A3 size, A4 size, legal size, executive size, etc. In this manner, processing can include the transfer of ink from a drum onto one or more pages that are copies of another document. In one example, the copies can be created from a master or original document.

In one example, the processing component 10 can print color and/or black and white images and/or text onto one or more pages. A user can select the type of text and/or images to be processed. In addition, the processing component 10 can copy one or more aspects of a particular document onto one or more disparate pages. In one example, the copy can be a “zoomed in” and/or enlarged portion of the particular document. Alternatively or in addition, copies can be made via the processing component 10 to one or both sides of a document and can be organized in post processing (e.g., collated, non-collated, etc.) as desired. Furthermore, one or more copies can be assembled together utilizing staples, paper clips, punched holes, etc. In one approach, three holes are punched on the margins of each copy after text and/or images have been placed on the document.

The marking component 12 can be employed to produce one or more marks on one or more media. Such marking can include one or more indentations, material removal, embossing, scoring, imprinting, stamping, etc. In one aspect, activation of the marking component can be done based on an event, when a particular condition is met, periodically, etc. For instance, a user can make a selection via a GUI to mark a document. The document can be marked at substantially anytime such as before processing, after processing or during processing of the document.

The mark produced by the marking component 12 can be indicative of one or more features, properties, characteristics of the document marked. In one example. the mark produced by the marking component 12 can indicate the author of the document and that the content contained therein has been reviewed and certified by such author. In another example, the mark placed on a document can indicate that the document is an original (e.g., not a copy) version. An original version can contain information that has been certified as correct and that should not be altered or modified.

By way of further example, the mark produced by the marking component 12 can prevent counterfeiting of a document. For instance, the mark made on a document can be difficult to reproduce by an unscrupulous user. One or more embossments on a document can contain one or more features and/or be located in a particular place on a document to signify one or more properties of the document. In one approach, one or more marks can indicate the document is one of a series of documents that contain particular content. In another approach, one or more marks can be placed in specific locations to indicate the originality and/or certification of the document. In this manner, an unauthorized user can be prevented from the creation and dissemination of information contained in one or more documents.

The marking component 12 can produce a particular type of mark that is specific to one or more entities that are producing the document wherein the document contains particular content. In one aspect, the mark is one or logos employed by one or more business entities. In another aspect, the mark is a particular alphanumeric string that is representative of particular information. For example, the string can include data such as time of day, location of document creation, document author, number of document in a series, etc.

The marking component 12 can be substantially any device that can permanently alter a media by deformation, material removal, indentation, etc. as noted above. In order to make such alteration, the marking component can employ one or more mechanisms to alter media. In one example, metal pin is mechanically driven into a media to indent the document similar to a dot matrix printer. The pin can be driven utilizing pneumatics, a spring, etc. to provide adequate force to permanently mark a media. Further, the pin can be coupled to a platen that can move along a plane in an “X” and “Y” motion to locate the pin in one or more particular location on the plane. The plane can be substantially parallel to a media that is marked by the marking component 12.

In another example, the marking component 12 can be a drum, roller, etc. coupled to a raised negative image (e.g., a die, etc.) that will be marked on one or more media. Such roller or drum can be located opposite a second roller wherein a document is fed between the rollers. As the document passes between the rollers, the roller coupled to the raised image can be pressed against the document with adequate force to produce a permanent mark on the document. As noted, the mark can be a logo, a symbol, an alphanumeric string, etc. In yet another example, the marking component is a laser marking system that can remove and/or discolor media to leave a distinguishing mark.

The configuration component 14 is coupled to the marking component to allow configuration of the marking component 12. Configuration can include but is not limited to specifying the location, content, type, etc. of mark produced on one or more media. In one example, a library can be employed that contains one or more desired marks. Such library can contain a previously used marks. In another example, the library can contain marks that a user may wish to employ at sometime in the future. By way of further example, the library can contain a combination of marks previously used and provide a means for the storage, organization and retrieval of one or more marks.

The configuration component 14 can allow one or more files to be imported that can be utilized to produce a mark on one or more media. In one example, the configuration component 14 can accept one or more of a .jpg, a .bmp, a .dwg, a .dxf, a .wmf, a .tif, a .gif, an .ai, etc. file type. Such file type can contain a particular design, and/or contain particular information desired by a user. The information contained within the file type can be processed by the configuration component 14 to provide instructions to a dot matrix printer to determine where to locate on or more dots (e.g., indentations) on a media. In this manner, one or more algorithms for processing particular file types can stored in a memory for subsequent utilization and/or retrieval.

In addition, the configuration component 14 can provide an editing interface to allow a user to modify one or more imported files. In one approach, the data contained within the file can be enlarged, reduced, truncated, etc. to keep only desired portions of a file to be employed with marking. Alternatively or in addition, a file can be inverted, flipped, duplicated, amended, etc. such that the mark created contains specific information desired by a user.

Further, the configuration component 14 can be an interface to allow a user to activate, deactivate or configure the marking component 12. In one example, a user can be presented with an interactive menu that contains one or more radio buttons that can be selected or deselected to specify how a document is to be processed and/or marked. In another example, the configuration component 14 can be located on the processing component 10 (e.g., printer) in the form of a GUI, touch screen, etc. Thus, a user can be

The configuration component can restrict access to the marking component 12 to limit use of the marking component 12 to only desired personnel. In one example, access restriction is accomplished by requiring a user to enter a username and a password to access a printing platform. The username and password is associated with an access level that relates to a particular set of functionality related to the printing platform. In one example, a first user can access only black and white toner to make copies. In another example, a second user can access a collation, a stapling, and a hole punching processing as well as access and configuration of the marking component. In this manner, marking of documents can only be done by authorized personnel. Such restricted access can insure that marked documents are original documents produced only by authorized personnel.

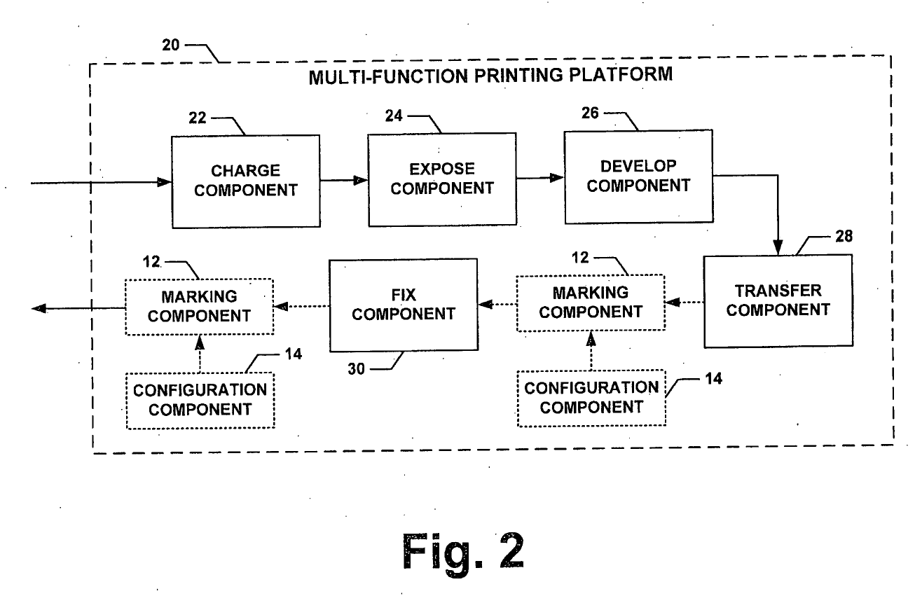

With reference to FIG. 2, a system that marks media is associated with a multifunction printing platform 20. The system includes the marking component 12, the configuration component 14, a charge component 22, an expose component 24, a develop component 26, a transfer component 28, and a fix component 30.

The charge component 22 can deposit a uniform electrostatic on a photoreceptor surface via a corona or similar discharge. In one approach, an organic photoreceptor is employed. Typically, organic photoreceptors are charged negatively to potentials of several hundred volts. Xerographic photoreceptors can be prepared on either electrically conducting substrates or substrates that contain a conducting surface layer. The thickness of most organic photoreceptors are between ten and thirty micrometers. In order to charge the photoreceptor, it may be necessary that the rate of thermal generation of free carriers be extremely low and that the free surface and substrate electrode not inject carriers into the photoreceptor in the dark. A further requirement is that the radiation emitted by the corona be very low, or filtered so that it is not absorbed by the photoreceptor. This can be accomplished by a very thin, ultraviolet absorbing, layer coated on the photoreceptor surface.

The expose component 24 exposes the photoreceptor with an optical image of the object to be reproduced. This selectively dissipates the surface charge in the exposed regions and creates a latent image in the form of an electrostatic charge pattern. The absorption of the image exposure by the photoreceptor creates electron-hole pairs. Under the influence of the corona-induced field, the pairs separate and are displaced to the free surface and the substrate electrode. As a result, the surface charge is dissipated in the exposed regions and an electrostatic charge pattern is created. In one example, an optical copier is employed wherein image exposure is reflected from a document, then imaged onto the photoreceptor through a lens. In one approach, the source of radiation is a Xenon filled lamp for flash exposures or a quartz-halogen or fluorescent lamp for scan or continuous exposures. For optical copiers, it is necessary that the photo-receptor have sensitivity throughout the visible region of the spectrum. For digital copiers or printers, the exposures are derived from either a laser or an array of light emitting diodes. In this case, it is necessary for the photoreceptor to be sensitive only at the emission wavelength of the laser or light emitting diode. Laser exposures are usually scanned across the photoreceptor surface by a spinning polygon mirror.

The develop component 26 transfers electrostatically charged toner particles are brought into contact with the latent image. Charged toner particles are transferred to the photoreceptor surface. There are several techniques by which this can be accomplished, most of which involve the use of a carrier. The more common of these processes are cascade and magnetic brush development. If the toner particles have a polarity opposite to the charged regions of the photoreceptor, they are attracted to the charged, or unexposed regions that correspond to the dark areas of the original image. This form of development is described as charged area development and used in most optical copiers. If the toner particles are of the same polarity, they are repelled from the charged regions and deposited in the discharged areas. This method is described as discharged area development and frequently used in digital copiers and printers. For these applications, it is preferable to expose the photoreceptor in regions that correspond to black areas of the original image, rather than expose the background areas. As the black areas of most originals are far less than the background, the exposure requirements are thus considerably reduced.

The transfer component 28 transfers toner particles from the photoreceptor to a media (e.g., paper, acetate, vellum, etc.) receiver. In one aspect, this can be accomplished by electrostatic transfer. In electrostatic transfer, a receiver is placed in contact with the toned image. The free surface of the paper is then charged by corona discharge with a polarity opposite that of the toner particles. The paper is then separated from the photoreceptor. Toner transfer occurs when the forces on the toner due to the fields from the charge on the paper exceed the adhesion forces between the toner and the photoreceptor.

The fix component 30 fuses the toner particles to the media. After toner particles are transferred to the media receiver by the transfer component 28, some form of fixing is required to render the image permanent. This can be accomplished by pressure, heat, radiation, solvent fixing, etc. Solvent fixing does not work wee with a wide range of receivers and requires complex solvent entrapment equipment, if solvent emissions to the atmosphere are to be avoided. Cold-pressure processes are limited to low volume applications and give lower image quality than hot-pressured processes. Further, cold-pressure fixing has special toner requirements. The advantages are that they require low power, and unlike hot roll processes, no standby power. In radiant fixing, heat generated from a quartz lamp or heated coil is used to melt the toner into the receiver. The basic limitation of radiant fixing is that the time required to heat the toner to the required temperature is such that the process is not amenable to high process speeds. Fusing temperatures are typically 120-130° C. A further limitation is thermal decomposition of the toner. For these reasons, processes that involve combination of heat and pressure are the most widely used. This can be accomplished by hot-roll pressure devices in which at least one roll is heated. In one approach, the fix component 28 employs silicone rubber heated rolls with poly (e.g., tetraflouroethylene, etc.) pressure rolls.

The marking component 12 can be situated in substantially any location within the multifunction printing platform 20. In one example, the marking component 12 can mark one or more media as the media is transferred from the transfer component 26 to the fix component 28. In this approach, the media will have a concave area that can be printed over. When the media is wiped after the media has been printed, a negative image can be obtained since the marked concave area will not receive a transfer of toner in the concave (e.g., indented, embossed, etc.) portions of the media. In one example, a pre-designated location can be indented and subsequently have a square of toner marked on an area surrounding the indentation to highlight the indentations in a field of toner. The result of such a process can be a square of dark ink wherein the indentation therein is white.

In another embodiment, the marking component 12 can mark one or more media after the fix component 28 has processed the media. In this approach, the media can be marked once toner or other material has been transferred and fused onto the surface of the media. The indentation placed on the media can be located in an area where toner has not been fused to the media. The result can be a media with an indentation similar to an embossed seal on a document.

The marking component 12 can be activated or deactivated based on one or more events, such as a pre-determined condition, an input, periodically, etc. For example, the marking component 12 can be linked to the multifunction printing platform 20 image output terminal/image drivers such that it is only engaged when requested. Activation of the marking component can be performed utilizing any number of means such as via a print driver, a user interface, etc. In one example, a user can click on an appropriate tab and further on a radio button within the tab to activate the marking component 12 associated with the multifunction printing platform 20. Activation of the marking component 12 can be protected such that only authorized users can access and configure the marking component 12.

The configuration component 14 can be coupled to the marking component 12 regardless of the marking component 12 location within the multifunction printing platform 20. As noted, the configuration component 14 can be employed to determine the location, size, depth, etc. of the mark placed on the one or more media processed by the multifunction printing platform 20. Such configuration can be performed utilizing any number of interfaces such as a graphical WYSIWYG interface, alphanumeric text within one or more location fields, etc. Each configuration can be stored in a memory (not shown), organized and edited for subsequent retrieval.

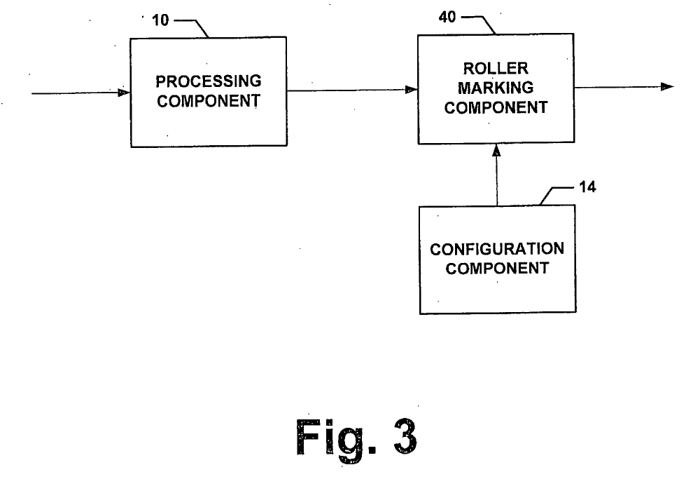

Turning now to FIG. 3, a marking system includes the processing component 10, the configuration component 14, and a roller marking component 40. The roller marking component 40 can be a rotating drum with a raised dimple signature (e.g., one or more words, logos, etc.). The drum can be rolled against a media sheet after printing has been completed. In one example, a media sheet is fed through two rollers. A first roller can be constructed of a hard material (e.g., steel, invar, carbide, nickel, etc.) wherein the roller contains a raised signature that creates an impression of a desired logo, text, etc. on the media sheet. A second roller can be constructed of a softer material such as an elastomer, rubber, polyurethane, etc. The die from the first roller can be pressed against the media sheet into the second roller. In this manner as a media sheet passes between the first and second rollers, a deformation can be created on the media sheet via the first roller without tearing the media sheet.

The location, size and height of the raised signature can be related to the size of a die attached to the roller marking component 40, as well as pressure, heat, etc. applied to the media paper as it contacts the roller marking component 40. One or more feed mechanisms can be employed to locate, move and transfer the media such that the location of the die relative to the media paper can be controlled. In one example, if a sufficiently large array of dimples is employed, simple text can be pressed into the media sheet. The drum and/or media paper handling can be activated and/or controlled by one or more components such as an image output terminal (not shown), for example.

Although a single raised dimple signature on the roller marking component 40 is illustrated, a plurality of dies that create a plurality of raised dimple signatures is also contemplated. In addition, the roller marking component 40 can be a plurality of rollers that contain one or more dies configured such that one or more marks can be created on one or more media sheets. For example, three rollers could each contain a disparate die representing a disparate mark, wherein only selected rollers are activated for different media sheets as desired.

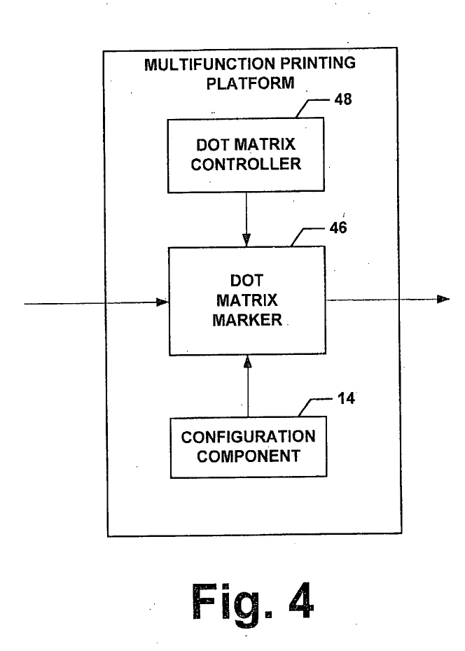

FIG. 4 illustrates a marking system that includes the configuration component 14, the multifunction printing platform 20, a dot matrix marker 46, and a dot matrix controller 48. The dot matrix marker 46 can employ one or more marking pins 50 that reside within a cartridge 52. The one or more marking pins 50 can be activated (e.g., when a pin is driven mechanically, pneumatically, etc.) upon command and the cartridge can be positioned via a platen (not shown) that moves the cartridge along a single plane of motion (e.g., positioning in both an X and a Y axis, etc.). The dot matrix controller 48 can govern the speed and/or direction of motion relative to one or more drive mechanisms. In one example, the dot matrix controller 48 controls two stepper motor drives to position the dot matrix marker in one or more desired locations. Thus, text and/or logos can be placed (e.g., indented, impressed, embossed, etc.) on media paper in substantially any size and in substantially any direction.

In addition, the dot matrix controller 48 can control when the one or more marking pins 50 are activated and coordinate such activation with the location of the dot matrix marker 46. In one example, once a desired location is reached, the one or more marking pins can be activated. For instance, activation of the one or more marking pins can be accomplished by utilizing a pneumatic drive system to fire the pin with sufficient force to permanently deform (e.g., indent, impress, emboss, etc.) the media paper. Once the pin is fired, the cartridge can be moved into one or more successive positions to fire the pin until the mark is complete.

A user can upload a desired logo to the configuration component 14 in a particular file format (e.g., .bmp, .tif, .pdf, .dxf, etc.). Upon receipt of the file, the configuration component 14 can utilize one or more algorithms to convert the logo to a series of commands. The dot matrix controller 48 can utilize such commands to drive one or more motor controllers and/or pneumatic devices to locate and fire the marker at one or more desired locations. In this manner, a series of impressions, indentations, etc. can be placed on the media paper to form the logo.

The configuration component 14 can provide one or more alias fields wherein one or more alphanumeric characters are representative of various data. For example, alias fields can be employed for the month, year, day of the month, day of the year, time of day, military time of day, serial numbers, device identification, etc. Information employed to populate data in the one or more alias fields can be retrieved from an internal processor, clock, or other data source. In this manner, information in one or more of the alias fields can be updated automatically.

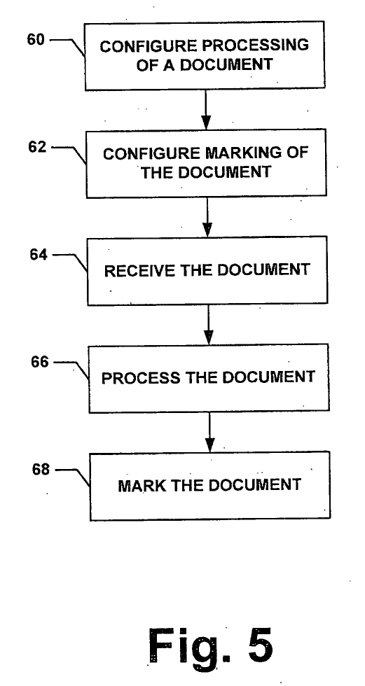

While, for purposes of simplicity of explanation, the methodologies of FIG. 5 is shown and described as executing serially, it is to be understood and appreciated that the exemplary embodiment is not limited by the illustrated order, as some aspects could, in accordance with the exemplary embodiment, occur in different orders and/or concurrently with other aspects from that shown and described herein. Moreover, not all illustrated features may be required to implement a methodology in accordance with an aspect of the exemplary embodiment.

With reference to FIG. 5, a methodology is shown that provides a mark on a document. In one example, such a mark can be employed to distinguish an original document from a copy. At reference numeral 60, document processing is configured. Such configuration can include one or more desired operations to implement during the processing of a document. In one example, operations can include stapling, binding, punching, etc. of a document. In addition, operations can further include copying, faxing, printing, or other manipulation of an image on a document.

An interface can be employed to allow a user to select one or more operations for implementation when processing the document. In one embodiment, such interface can appear in association with printing a document. For instance, an interface can include one or more radio buttons and/or check boxes that can be selected/deselected by a user. Each radio button and/or check box can be representative of a single operation, e.g., stapling, punching, collating, imaging, binding, etc. In another approach, an interface is employed in association with a printer driver wherein a user can configure one or more operations employed with a multifunction printing platform.

At 62, document marking is configured. Marking configuration can include the type of mark, the location of the mark, the content of the mark, etc. The type of mark can include one or more of embossing, impressing, indenting, material removal, laser etching, etc. The choice of mark can depend on the type of media paper utilized, the type of mark desired, etc. An interface such as the one employed to configure the processing of the document can be employed to configure the mark. For example, an interface can allow a user to select the type of mark (e.g., emboss, laser etch, indent, etc.) placed on the document as well as the location, size, etc. of the mark. In one approach, a display contains a field representative of a particular document size. One or more desired marks can be located and displayed to a user. In this manner, a user can preview a mark prior to application to a document.

Each aspect of the mark can be configured by a user utilizing an interface, one or more mechanical means, etc. In one example, the mark placed on a document can signify that the document is an “original” and not a duplicate. An “original” mark can signify that content contained within a document has been scrutinized and validated. Thus, an “original” mark can signify that a document can be copied without compromising data content.

At 64, a document is received. Such document can be received by a processing component such as a printing platform, multifunction printing platform, etc. In one embodiment, reception of the document can occur when a signal indicates a document for printing has been received. For example, a signal can be sent from a facsimile machine, a computer, a processor, etc. Once such a signal is received, paper can be drawn from a source (e.g., tray, stack, etc.) to one or more processing components. At 66, the document is processed. Such processing can include printing, image placement, toner selection, stapling, binding, punching, etc.

At 68, the document is marked. Marking can include laser marking, embossing, impressing, etc. In one example, a roller drum is employed to place a company logo on a document when such marking has been previously configured. In another example, an alphanumeric string is placed on the top of each sheet via a dot matrix marking process. Marking can occur at substantially any time and/or location relative to processing of the document. In addition, marking can be initiated by a user via a local interface, a remote interface, in association with a driver, etc. Marking of a document can provide one or more characteristics that distinguish an original version of a document from one or more copies.

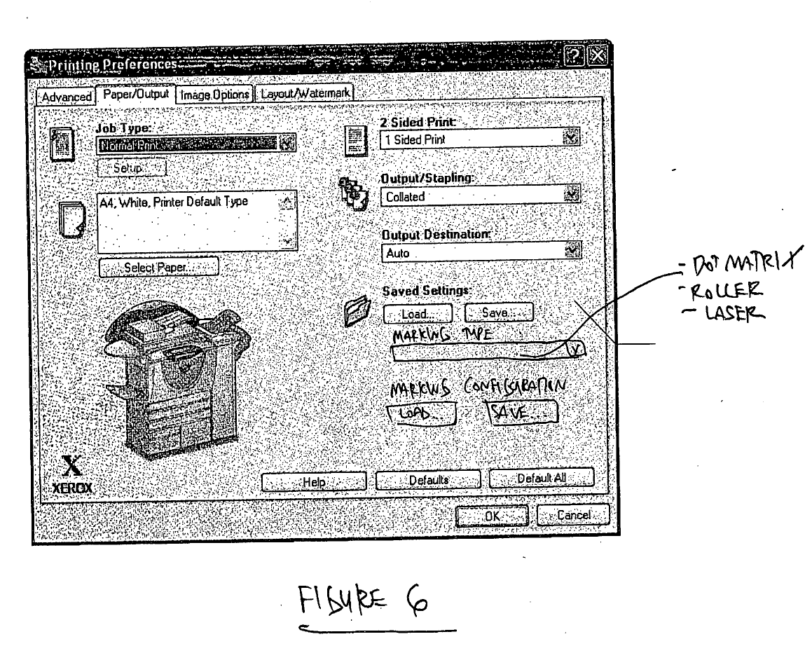

FIG. 6 illustrates an exemplary user interface tab that is associated with a printer driver. Such interface can be presented to a user at a desktop PC when configuring a print job. In this example, a plurality of fields allow a user to configure various aspects of a print job including “job type,” “paper size,” “paper source,” “2-sided printing,” “output/stapling,” “output destination,” and/or “saved settings” fields. In addition, a “marking” field is illustrated wherein a user can select whether or not to activate marking of the paper and which marker to utilize for such marking. The device employed to produce the mark can be selected such as a dot matrix marker, a roller marker, a laser marker, etc.

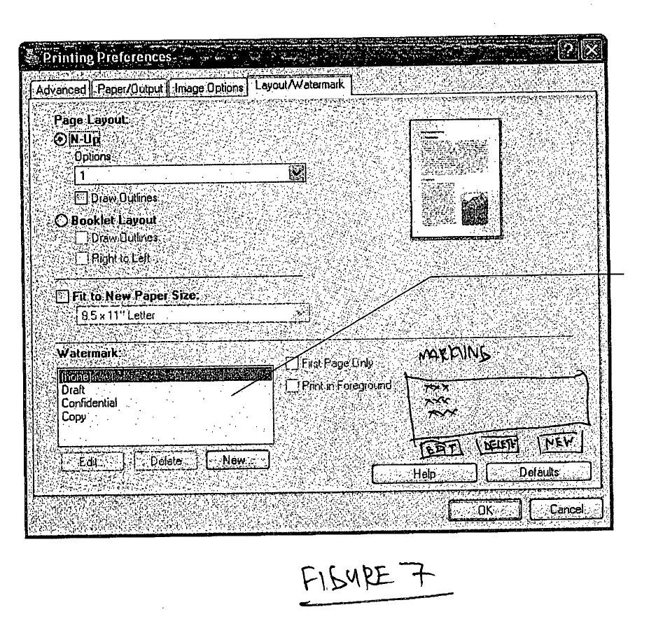

FIG. 7 illustrates another user interface tab that can be configured to determine the location of the mark, the type of mark (e.g., alphanumeric text, logo, graphic, etc.), the content of the mark, the size of the mark, etc. Such configuration can be saved and labeled for subsequent retrieval and/or deleted. In one example, a configuration is saved as “Original Word Mark,” wherein a roll marker places embosses the word “ORIGINAL” in the top right hand corner of a letter size piece of paper. A “Marking” field can contain one or more save marking configurations for easy review and selection by a user.

FIGS. 6 and 7 can employ one or more security measures to insure that the correct personnel have access to the marking option. In this manner, only qualified personnel can provide the proper content for documents that should receive a particular mark (e.g., “ORIGINAL”, company logo, etc.) Further, unscrupulous users can be prevented from creating and circulating counterfeit documents.

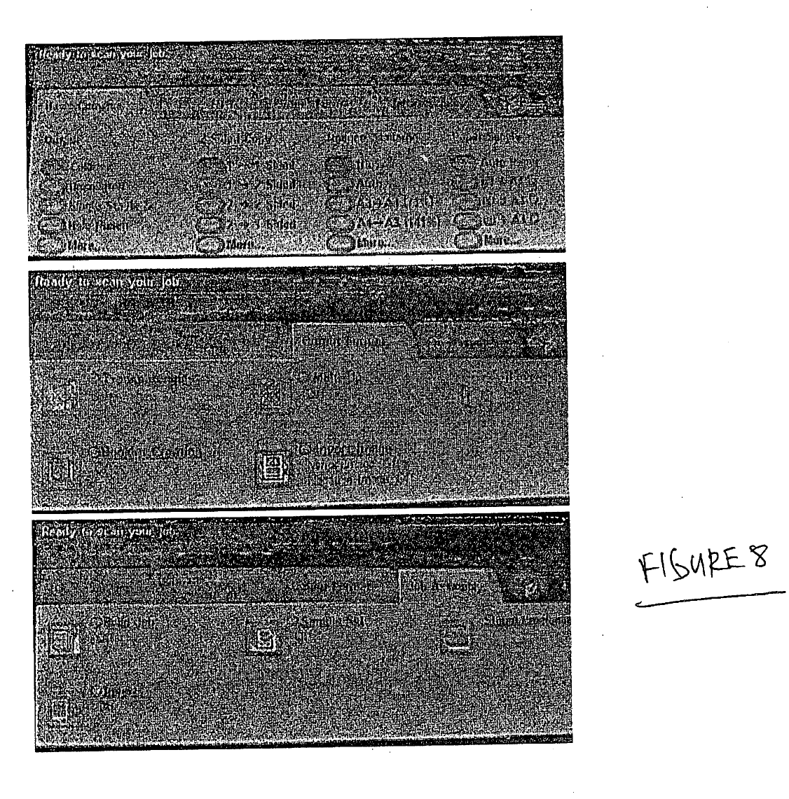

FIG. 8 illustrates a user interface that is employed on a multifunction printing platform. Such user interface can be employed with one or more functions such as printing, copying, faxing, etc. A marking field can contain one or more radio buttons wherein a user selects one or more preconfigured marks. In addition, a user can configure the mark via one or more fields that contain various parameters such as location of the mark, content of the mark, size of the mark, and marking device. After configuration, the user can select a title for subsequent retrieval. This title can be stored in a list for user selection or deletion.

In addition, one or more security measures can be employed to allow only qualified personnel to access marking configuration and selection. For example, a user can be asked login to the multifunction printing platform by entering a username and password. A username can be associated with a particular security level which allows access to one or more aspects of machine operation such as marking activation and configuration. In this manner, only qualified personnel can create marks on documents. This can insure that marked documents contain the proper content both as a quality control measure and a counterfeit prevention tool.

It will be appreciated that variations of the above-disclosed and other features and functions, or alternatives thereof, may be desirably combined into many other different systems or applications. Various and variant embodiments presently unforeseen or unanticipated alternatives, modifications, variations or improvements therein may be subsequently made by those skilled in the art which are also intended to be encompassed by the following claims. In addition, the claims can encompass embodiments in hardware, software, or a combination thereof.

1. A system that marks a document, comprising:
a processing component that at least one of copies, prints, faxes, configures imaging, staples, collates and hole punches a document;
a marking component that produces one or more marks on a document received from the processing component; and
a configuration component that allows configuration of the marking component.

2. The system according to claim 1, wherein the document is one of paper, acetate and velum.

3. The system according to claim 1, wherein the document is one of letter size, A3 size, A4 size, legal size, and executive size.

4. The system according to claim 1, wherein the marking component is one of a dot matrix marker, a roll marker, and a laser marker.

5. The system according to claim 4, wherein the laser marker removes material from the document and discolors the document.

6. The system according to claim 1, wherein the configuration component can allow a user to configure at least one of mark location, mark size, mark type, type of marking device, and mark content.

7. The system according to claim 6, wherein the mark content is one or more of a time of day, a location of document creation, a document author, a number of document in a series, an alphanumeric string, and a logo.

8. The system according to claim 1, wherein marking the document can include at least one of one or more indentations, material removal, embossing, scoring, imprinting, and stamping.

9. The system according to claim 1, wherein the configuration component is a user interface that can be accessed on at least one of a personal computer, a tablet PC, a handheld PC, a cell phone, and on a multifunction printing platform.

10. The system according to claim 1, further including:
a security component that allows access to the configuration component only to users that provide appropriate data.

11. The system according to claim 4, wherein the dot matrix marker includes a pin inside of a pin cartridge, wherein the pin is driven from the pin cartridge utilizing at least one of pneumatics and a spring to impact and permanently mark the document.

12. The system according to claim 11, wherein the pin is coupled to a platen that can move along a plane in at least one direction, wherein the plane is substantially parallel to the document and the pin is activated when the pin is in one or more desired locations.

13. The system according to claim 4, wherein the marking component is a roll marker, wherein a first roller is coupled to a raised image and located opposite a second roller wherein a document is fed between the first and second rollers such that as the document passes between the rollers, the roller coupled to the raised image is pressed against the document with adequate force against the second roller to produce a permanent mark on the document.

14. A multifunction printing platform that copies information from an original document to one or more document copies, comprising:
a charge component that deposits a uniform electrostatic on a photoreceptor surface a discharge;
an expose component that exposes the photoreceptor of the charge component with an optical image of the information to be reproduced from the original document;
a develop component transfers electrostatically charged toner particles that are brought into contact with the latent image wherein charged toner particles are transferred to the surface of the photoreceptor of the charge component, wherein the toner particles are representative of the information to be transferred from the original document to at least one document copy;
a transfer component that transfers the toner particles from the photoreceptor to the at least one document copy;
a fix component that fuses the toner particles transferred to the at least one document copy by the transfer component;
a marking component that places one or more marks on a document received from the fix component; and
a configuration component that configures one or more attributes of the one or more marks placed by the marking component.

15. The system according to claim 14, wherein the marking component receives one or more document copies from the transfer component, marks the one or more document copies and transfers the document to the fix component.

16. The system according to claim 14, wherein the marking component is at least one of a dot matrix marker, a roll marker and a laser marker.

17. The system according to claim 14, wherein the configuration component allows a user to determine at least one of location, size, depth, of the mark placed on the one or more document copies.

18. A method for marking a document to distinguish an original document from a copy, comprising:
configuring processing of a document including at least one of stapling, binding, punching, copying, faxing, printing, and image manipulation on a document;
configuring marking of the document by determining at least one of mark location, mark depth, mark size, marker type, and mark content;
receiving the document;
processing the document by at least one of stapling, binding, punching, copying, faxing, printing, and image manipulation of the document based at least upon the configuration of the processing of the document; and
marking the document with a permanent indentation based at least upon configuration of the marking of the document that provides at least one characteristic that distinguishes an original document from a document copy.

19. The method of claim 18, wherein marking the document is done utilizing at least one of a dot matrix marker and a roll marker.

20. The method of claim 18, wherein at least one or configuring processing and configuring marking is accomplished via a user interface.
